(19) United States
(12) Patent Application Publication
(10) Pub. No.: US 2017/0104232 A1
(43) Pub. Date: Apr. 13, 2017

(54) Mini hydrogen battery charger

(71) Applicant: Haiming Li, Braintree, MA (US)

(72) Inventor: Haiming Li, Braintree, MA (US)

(21) Appl. No.: 14/878,806

(22) Filed: Oct. 8, 2015

(51) Int. Cl. H01M 8/0656; C25B 15/02

(52) U.S. Cl. CPC H01M 8/0656; C25B 15/02

(57) ABSTRACT

A configuration for a mini hydrogen battery charger includes an electrolysis cell, a purification chamber and an alterable color drying tower. A purification chamber ensures that the device can use regular water, instead of deionized water, for hydrogen generating. In various embodiments, the configuration includes fewer parts then other devices decrease the risk of hydrogen leakage and improve the user experience.

### DESCRIPTION OF RELATED ART

Hydrogen battery is one of the latest technologies for energy storage in daily life. Its tiny volume and longer using time (compared with the battery technologies, the using time can increase to weeks or months) make it have a bright future. The shape and function are similar with traditional batteries, but need to be applied with fuel cell for electrical power. On the other hand, the hydrogen battery must be charged with professional charger.

Hydrogen battery charger must be safe and convenient to people. One of the technologies for generating hydrogen is water electrolysis. Many prior-arts are attempting to design a friendly device with water electrolysis for charging the battery. They are focusing on the theoretical structure design or complicated system.

For example, U.S. Pat. No. 7,727,647 describes a block diagram for hydrogen fuel container charger. A portable fuel cell charger has a water source and an electrolyzer coupled to the water source and adapted to be coupled to a power source.

U.S. Pat. No. 6,569,298 describes a complicated system contains a capacitive deionization device, water electrolysis device and storage system.

### SUMMARY

A typical challenge in using a Mini Hydrogen battery charger (electrolysis technology) is that electrolysis can only use de-ionized water instead of regular (tap) water. A typical water purifier is hard to take around while you are travelling. This patent is a special design of integration of water purification chamber inside a MINI portable Hydrogen Battery Charger with electrolysis stack, so that there is no need to carry around an inconvenient water de-ionizer/purifier.

We design the water purification chamber to be a special shape (FIG. 1) so that this device can take regular water from the inlet on the top, and produce deionized water for electrolyzer underneath. The water inlet will be sealed after each water refill, to prevent water from spilling during travel. The materials inside of purification chamber need to be replaced if the materials' color changes. Patent also includes a design for a one-way valve between water purification chamber and electrolysis cell, which will only allow de-ionized water to go from the chamber to the stack, instead of the other way around. In order to integrate this water purification chamber into this battery charger, the other components also have to be extremely simplified. Meanwhile, the design includes fewer parts than other hydrogen generators, so the risk of hydrogen leakage is less. For instance, the designs includes only one safety valve, one pressure switch and one gas connector, which is much more simple than the other products in the market.

Therefore, high efficiency, safety and low cost hydrogen battery charger is an effective solution for charging hydrogen batteries.

### BRIEF DESCRIPTION OF THE DRAWINGS

Various embodiments will be described with respect to the following accompanying drawings:

FIG. 1 is a perspective view of an example look of a mini hydrogen battery charger, in accordance with one embodiment.

FIG. 2 is one of the cut-off views of the internal structural configuration of a mini hydrogen battery charger, in accordance with one embodiment.

FIG. 3 is the other cut-off view of the internal structural configuration of a mini hydrogen battery charger, in accordance with one embodiment.

FIG. 4 is the working process of a mini hydrogen battery charger, in accordance with one embodiment.

### DETAILED DESCRIPTION OF EXAMPLE EMBODIMENTS

The present application discloses a special structural configuration of an electrolysis stack that enables adjusting the operation capacity of the electrolysis stack while ensuring the quality of the electricity connection.

Embodiments of the electrolysis stack and various components thereof are described herein in detail. It is to be understood, however, that features described with reference to one or more embodiments need not, in general, be present in all embodiments. Accordingly, the described example embodiments are to be considered illustrative and not limiting.

For simplicity and clarity of illustration, the accompanying figures illustrate the general manner of construction, and description and details of well-known features and techniques may be omitted to avoid unnecessarily obscuring the invention. Additionally, elements in the figures are not necessarily drawn to scale; some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition. It is contemplated and intended that the configuration disclosed herein apply to the structure of an electrolysis stack which can adjust its capacity to different types of electricity input; for the sake of clarity, the examples provided herein refer to either solar power or wind-generated power. Furthermore, it is contemplated and intended that the systems and methods disclosed herein may be used in combination with any type of electrolysis technology. Technologies for hydrogen generation through water electrolysis currently available and well-known to those of ordinary skill in the art include proton exchange membrane (PEM) technology and alkaline technology. PEM electrolysis is the electrolysis of water in a cell equipped with a solid polymer electrolyte (SPE) that is responsible for the conduction of protons, separation of product gases, and electrical insulation of the electrodes. Alkaline electrolysis uses alkaline as the electrolyte. As will be readily appreciated, however, the embodiments described herein are not limited to these two electrolysis technologies, but are amenable to use in conjunction with other electrolysis technologies as well, and a person of ordinary skill in the art will know the necessary modifications and changes to be made.

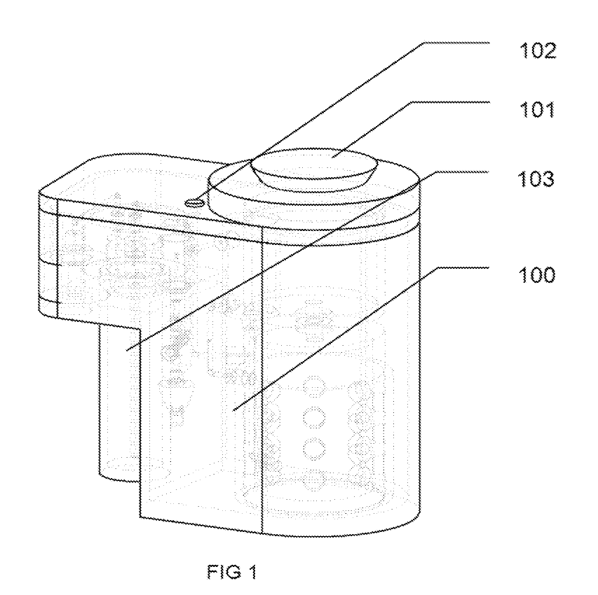

In FIG. 1, an example configuration of a mini hydrogen battery charger 100 is shown. The design of mini hydrogen battery charger 100 is tiny size and easily traveled with user. The mini hydrogen battery charger 100 uses electricity as its power for hydrogen generation. And a power converter (not shown in the FIGS. 1, 2, 3), or solar panel, or others, as an accessory, is connected the charger 100 with a removable cable, rectifying the AC power, or the renewable power to stabilized DC power. In addition, a removable sealing cover 101 and an oxygen outlet sealing part 102 ensure the tightness of charger 100, which allow the charger 100 to be rotated without leakage. And the drying tower 103 is to be replaced after the end of its lifetime.

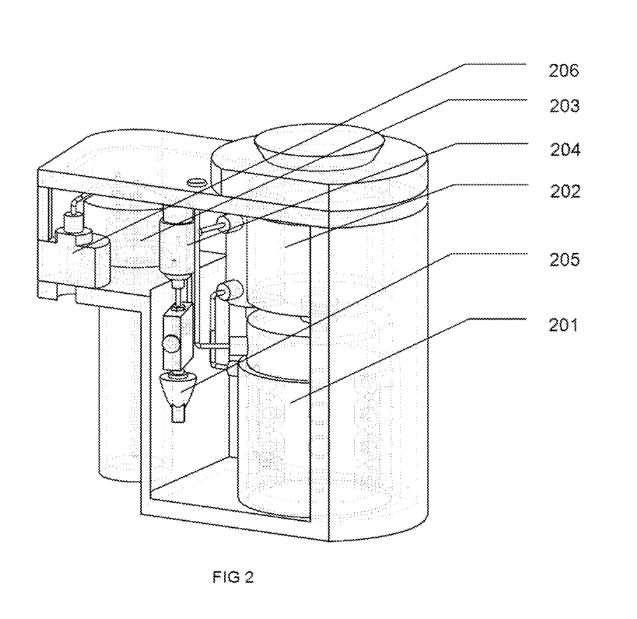

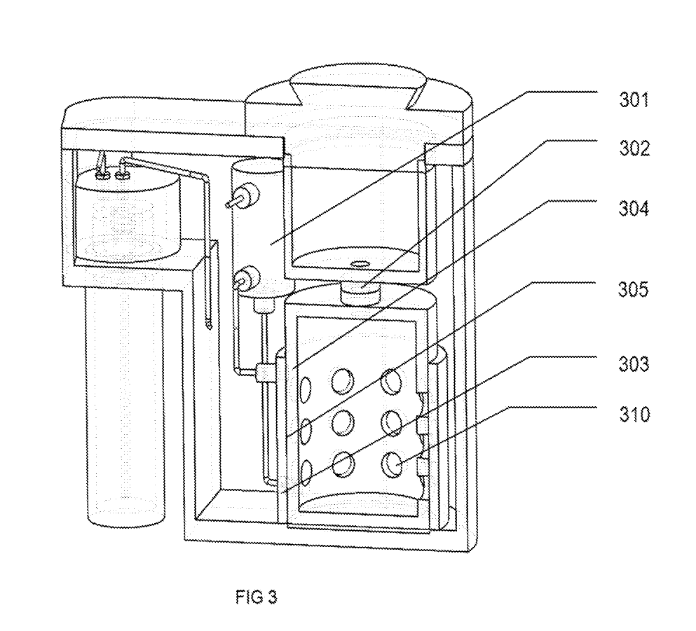

The internal structure example is shown in FIG. 2 and FIG. 3. The design structure includes electrolysis cell 201, a purification chamber 202, gas/liquid separator 301, drying tower holder 203, one way valve 302, safety valve 204, pressure switch 205 and hydrogen battery holder 206 (hydrogen outlet). Electrolysis cell 201 is one of the most important parts of the charger 100, which generates hydrogen gas for storing in a hydrogen battery. Electrolysis cell 201 is combined with cathode 303, anode 304 and membrane 305, and for the purpose of portable design, is processed as a container, for example, a cylinder (in the example shown in FIG. 2 and FIG. 3), a cube or etc. Inside of the electrolysis cell 201, multiple holes 310 are manufactured on the anode 304 side of the cell, for forming the electrolyte circuit. A one way valve 302 is connected with electrolysis cell 201 and purification chamber 202. One way valve 302 allows the liquid and gas to flow pass itself only in one direction, so to guarantee the electrolyte can't flow back to purification chamber 202. The chamber 202 is one of the another important part in charger 100, can let user directly use the regular water instead of doing the preparation for deionized or distilled water, which is a very convenient way. Meanwhile, Safety valve 204 and pressure switch 205 are the safety precautions for people and device. Pressure switch 205 is an electrical valve, which can shut down the power for electrolysis cell 201 when the system reaches its limitation and turns the indicate light from red to green. And the safety valve 204 is the last protection. If the pressure of system is over the limit of pressure switch 204, but electrical error occurs to pressure switch 205, and pressure keeps increasing, when it reaches the maximum pressure of safety valve 204, the high pressure hydrogen gas can vent to atmosphere though safety valve.

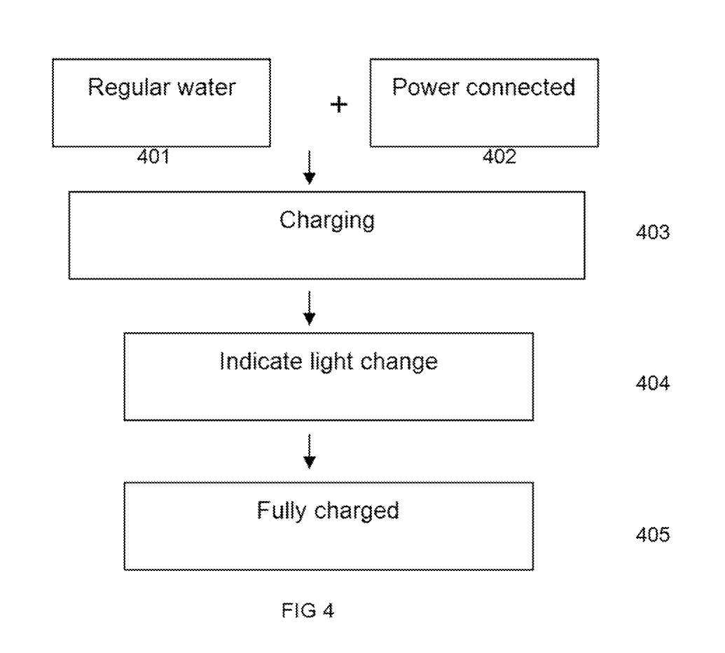

Operation process is simplified, shown in FIG. 4. Regular water 401 is the only resource for mini hydrogen battery charge. Add water 401 to purification chamber 202 and connect with electrical power 402 (no mater from grid or renewable power source). Meanwhile, an empty or not fully charged hydrogen storage battery should be installed at hydrogen battery charger 206 (hydrogen outlet). Finally, turn the power on and wait for the hydrogen storage battery to be charged 403. An indication light for charging status may change from red to green 404 when it is fully charged 405.

When we look at this inside of mini hydrogen battery charger 100, more details can be found. The regular water 401 is purified by purification materials in purification chamber 202 and becomes deionized water, and then flows into electrolysis cell 201. After that, under the electrical power, water has a chemical decomposition to hydrogen and oxygen on the cathode 303 side and anode 304 sides respectively. Oxygen vents to outside though oxygen outlet, and hydrogen is be pressurized, dried and stored. Some electrolyte may flow with the hydrogen to gas/liquid separator 301, then flows back and mixes with other electrolyte in electrolyte cell 201. The holes 310 on anode side are necessary for electrolyte circuit. Replaceable drying tower 103 is installed on the drying tower holder 203. It may lose its effect when the color obviously changes. Similarly, the purification materials in purification chamber 202 may lose their function as well when their color changes after long term use. What's more, the lifetime of purification materials is same as drying tower.

As will be recognized by those skilled in the art, the innovative concepts described in the present application can be modified and varied over a large range of applications. Accordingly, the scope of the claimed subject matter shall not be taken as limited by any of the specific example embodiments described. It will be appreciated that various alternatives modifications and variations are possible without departing from the scope of the present disclosure.

Further, none of the description in the present application should be read as implying that any particular element, step or function is an essential element which must be included in the claim scope. Moreover, none of the claims are intended to invoke paragraph six of 35 USC section 112 unless the exact words “means for” are followed by a participle.

What is claimed is:

1. A mini hydrogen battery charger is portable and easily to be held with one hand.

2. The device of claim 1, wherein the hydrogen battery charger is sealed.

3. A mini hydrogen battery charger comprising:
an electrolysis cell, with the extra function as a container;
a water purification chamber,
an alterable color dying tower;
a pressure switch to control the electrical status
a safety valve to guarantee the security.

4. The device of claim 3, wherein the shape and function as a container of electrolysis cell, can easily store the resource of reaction.

5. The device of claim 3, wherein the chamber can purify the regular water to deionized water is combined inside of hydrogen battery charger.

6. The device of claim 3, wherein the alterable color dying tower can change its color when absorbs enough moisture.

7. The device of claim 3, wherein the pressure switch indicates the hydrogen battery whether or not fully charged.

8. The device of claim 5, wherein there are holes on anode side for electrolyte circuit loading correctly.

9. The device of claim 6, wherein the alterable color also indicates the lifetime of purification materials.
